(19) United States
(12) Patent Application Publication
(10) Pub. No.: US 2017/0159341 A1
(43) Pub. Date: Jun. 8, 2017

(54) DOOR CHECKER DEVICE FOR VEHICLE

(71) Applicant: Hyundai Motor Company, Seoul (KR)

(72) Inventor: Youngbum Cho, Seoul (KR)

(21) Appl. No.: 15/192,589

(22) Filed: Jun. 24, 2016

(30) Foreign Application Priority Data
Dec. 8, 2015 (KR) 10-2015-0174029

(51) Int. Cl. E05F 5/02; E05D 3/12; E05D 3/18; E05D 5/02

(52) U.S. Cl. CPC E05F 5/025; E05D 5/0207; E05D 3/127; E05D 3/18

(57) ABSTRACT

A hinge type door checker device positioned extraneous to a door is provided. The door checker device includes a first bracket, a second bracket, and a checker arm. The first bracket is fixed to a filler part of a side outer panel of a vehicle body, and is formed with a slit parallel to a length direction of the vehicle body. The second bracket is fixed to a hinge mounting part of a door inner panel, and is formed with openings. The checker arm includes a first end portion of the vehicle body rotatably and slidably combined with the first bracket, a second end portion of a door rotatably combined with the second bracket by a second hinge pin inserted into the openings.

### CROSS-REFERENCE TO RELATED APPLICATION

This application claims priority to and the benefit of Korean Patent Application No. 10-2015-0174029 filed in the Korean Intellectual Property Office on Dec. 8, 2015, the entire contents of which are incorporated herein by reference.

### BACKGROUND

(a) Field of the Invention

The present invention relates to a door checker device for a vehicle, and more particularly, to a hinge type door checker device disposed on an exterior of a door.

(b) Description of the Prior Art

In general, door checker devices are used in vehicles to limit the opening degree of a door when the door is rotated and opened. A door checker device prevents abrupt rotation of a door when the door is opened, and allows the door to maintain a stationary position where it is held open, thereby enhancing convenience of the passenger when entering or exiting the vehicle.

A roller type door checker, a slider type door checker, and the like are disclosed as door checker devices in the related art. The conventional door checker device is disposed in an outside panel of a vehicle body inside a door and an inside panel of the door, and has a structure in which a checker arm is rotated based on an opening extent of the door when the door is opened. In addition, an operating trajectory of the conventional door checker device varies inside the door due to the rotation, and the operating trajectory of the door checker device should not be separated by door inner parts, such as a door glass and the like, to prevent interference by the door inner parts. Accordingly, a layout of the door checker device and the door inner parts are complex, thereby decreasing a degree of freedom in the design.

The above information disclosed in this section is merely to enhance the understanding of the background of the invention and therefore it may contain information that does not form the prior art that is already known in this country to a person of ordinary skill in the art.

### SUMMARY

The present invention provides a vehicle door checker device with an increased degree of freedom in the design that prevents interference between a door checker device and door inner parts.

A door checker device according to an exemplary embodiment of the present invention may include a first bracket, a second bracket, and a checker arm. The first bracket may be fixed to a filler part of a side outer panel of a vehicle body, and may be formed with a slit parallel to a length direction of the vehicle body. The second bracket may be fixed to a hinge mounting part of a door inner panel, and may be formed with openings. A checker arm may include an end portion of the vehicle body rotatably and slidably combined with the first bracket, an end portion of a door rotatably combined with the second bracket by a second hinge pin inserted into the openings.

The first bracket may include a pair of second horizontal portions disposed perpendicular to the filler part of the vehicle body and that vertically face each other, and the slit may be formed in each of the pair of first horizontal portions. The second bracket may include a pair of second horizontal portions disposed perpendicular to the hinge mounting part and that vertically face each other, and the openings may be respectively formed in the pair of second horizontal portions. The checker arm may include a pair of arms. The first hinge pin may be inserted into a first end of the pair of arms and the pair of slits, and the second hinge pin may be inserted into a second end of the pair of arms and the pair of openings.

A slider may be fixed to a shaft of the first hinge pin, and a guide may be fixed to an exterior of the filler part of the vehicle body that corresponds to a moving path of the slider to contact the slider. An exterior surface of the guide that contacts the slider may be formed with a plurality of detent protruding surfaces spaced apart from each other along a moving direction of the slider. The plurality of detent protruding surfaces may include, after the door is closed, a first protruding surface spaced apart from the slider, at least one second protruding surface spaced apart from the first protruding surface, and a third protruding surface spaced apart from the second protruding surface to contact, after the door is fully open, the slider. The door checker device may further include a hydraulic damper. The hydraulic damper may be fixed to the part of the vehicle body and may contact, after the door is fully open, the slider to absorb an impact.

Meanwhile, the door checker device may further include a hydraulic pressure cylinder having a piston rod with a first end fixed to the first hinge pin for linear motion together with the first hinge pin. The hydraulic pressure cylinder may include a cylinder body that accommodates a fluid in a sealed state, and a piston fixed to a second end of the piston rod inside the cylinder body and including at least one orifice.

The door checker device according to the current exemplary embodiment is not interfered by the door inner parts since it is positioned extraneous to the door. Accordingly, when designing the door parts, layout difficulty of the door parts associated with the door checker device is prevented and thus, a degree of freedom in the design may be increased. In addition, the door checker device may use a combination of a guide and a slider or a hydraulic pressure cylinder to generate a door holding force, and may use a hydraulic damper to reduce a resistive force of the door.

### BRIEF DESCRIPTION OF THE DRAWINGS

The accompanying drawings, which are included to provide a further understanding of the invention and are incorporated in and constitute a part of this application, illustrate exemplary embodiment(s) of the invention and together with the description serve to explain the principle of the invention. In the drawings:

FIG. 1 is a perspective view of a door checker device according to a first exemplary embodiment of the present invention;

FIG. 2 is a top plan view of the door checker device according to the first exemplary embodiment of the present invention;

FIGS. 3 to 5 are top plan views of the door checker device according to the first exemplary embodiment when a door is opened;

FIG. 6 is a cross-sectional view of the door checker device of FIG. 1 taken along the line VI-VI according to the first exemplary embodiment;

FIG. 7 is a partial enlarged view of FIG. 6 according to the first exemplary embodiment;

FIG. 8 is a perspective view of a door checker device according to a second exemplary embodiment of the present invention;

FIG. 9 is a cross-sectional view of one example of a hydraulic pressure cylinder illustrated in FIG. 8 according to the second exemplary embodiment; and

FIGS. 10 and 11 are perspective views of a door checker device according to a third exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention.

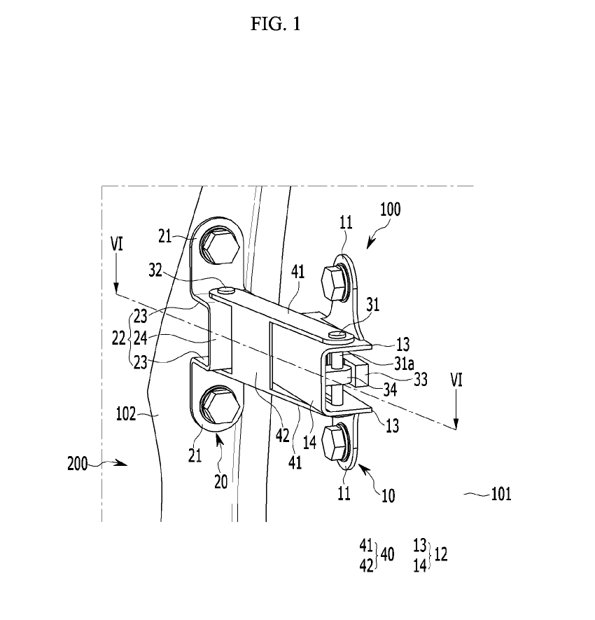

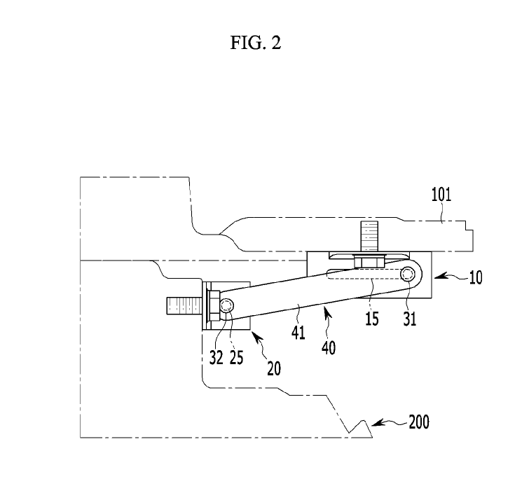

Referring to FIGS. 1 and 2, a door checker device 100 of a first exemplary embodiment may include: a first bracket 10 fixed to a filler part 101 of a side outer panel of a vehicle body; a second bracket 20 fixed to a hinge mounting part of a door inner panel 102; and a checker arm 40 combined to the first and second brackets 10 and 20 through first and second hinge pins 31 and 32.

An end portion of the checker arm 40 (e.g., a first end portion of the checker arm 40) at a vehicle body side may be connected to the first bracket 10 through the first hinge pin 31, and an end portion of the checker arm 40 (e.g., a second end portion of the checker arm 40) at a door side may be connected to the second bracket 20 through the second hinge pin 32. The door checker device 100 may be positioned extraneous to the door 200 (e.g., on an exterior surface of the door 200), and when the door 200 is opened, the checker arm 40 provides linear motion. The first bracket 10 may include a pair of first flanges 11 fixed to the filler part 101 of the vehicle body, and a first bracket body 12 bent from the pair of first flanges 11 to protrude outward of the filler part 101 of the vehicle body. The pair of first flanges 11 may be disposed or arranged vertically, and may be fixed to the filler part 101 of the vehicle body by fastening bolts or other fastening mechanism.

The first bracket body 12 may include a pair of first horizontal portions 13 vertically bent from the first flanges 11, and a first vertical portion 14 that integrally connects the pair of first horizontal portions 13. The first vertical portion 14 may be disposed parallel to the filler part 101 of the vehicle body, and may be disposed to be separated from the filler part 101 of the vehicle body by a width of the first horizontal portion 13. Additionally, slits are formed in the pair of first horizontal portions 13 to be parallel to a length direction of the vehicle body 15. The second bracket 20 may include a pair of second flanges 21 fixed to the hinge mounting part 102 of the door inner panel, and a second bracket body 22 bent from the pair of second flanges 21 to protrude outward of the hinge mounting part 102. The pair of second flanges 21 may be disposed or arranged vertically, and fixed to the hinge mounting part 102 of the door inner panel by fastening bolts or other fastening mechanisms.

Further, the second bracket body 22 may include a pair of second horizontal portions 23 vertically bent from the second flange 21, and a second vertical portion 24 that integrally connects the pair of second horizontal portions 23. The second vertical portion 24 may be disposed parallel to the hinge mounting part 102 of the door inner panel, and may be disposed to be separated from the hinge mounting part 102 by a width of the second horizontal portion 23. Additionally, circular openings 25 may be formed in the pair of second horizontal portions 23. The checker arm 40 may include a pair of arms 41, and a connecting portion 42 that connects the pair of arms 41. The pair of arms 41 may contact the pair of first horizontal portions 13 and the pair of first horizontal portions 23 outside thereof. The pair of first horizontal portions 13 and the pair of second horizontal portions 23 may be fixed to have about the same height.

The end portion of the checker arm 40 at the vehicle body side may be connected with the first bracket 10 by the pair of arms 41 and the first hinge pin 31 inserted into the pair of slits 15. The door side end portion of the checker arm 40 may be connected with the second bracket 20 by the pair of arms 41 and the second hinge pin 32 inserted into the pair of openings 25. A shaft 31a of the first hinge pin 31 may be positioned inside of the first bracket body 12, and a shaft (not shown) of the second hinge pin 32 may be positioned inside of the second bracket body 22.

When the door 200 is opened, the second bracket 20 may be rotated based on a hinge shaft (not shown) of the door 200, and the end portion of the checker arm 40 at the door side (e.g., the second end portion of the checker arm 40) may be rotated by the second hinge pin 32 based on the openings 25. Simultaneously, the end portion of the checker arm 40 at the vehicle body side (e.g., the first end portion of the checker arm 40) may slide along the slit 15 while being rotated by the first hinge pin 31.

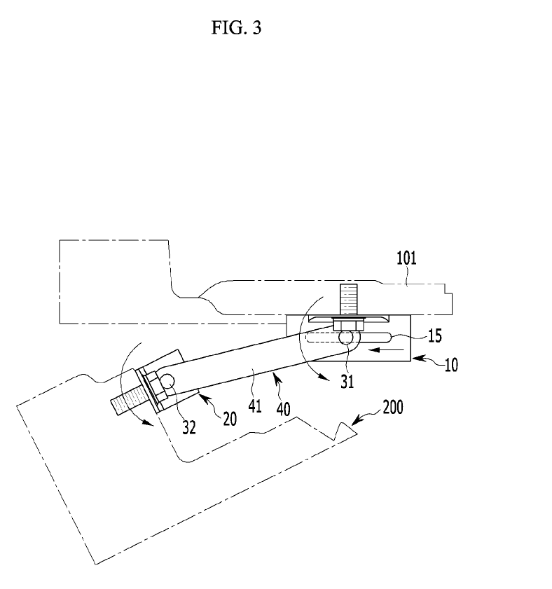

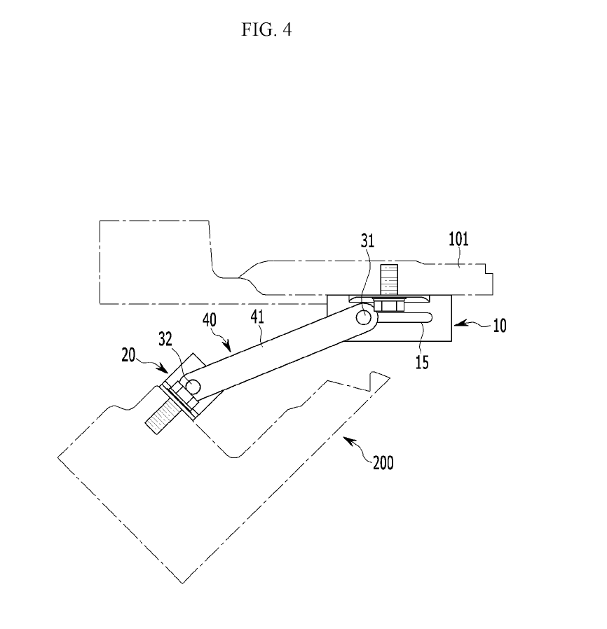

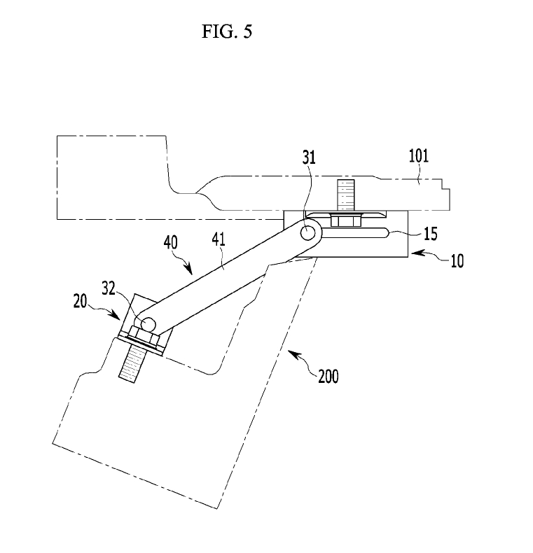

FIG. 2 illustrates the door being closed. Referring to FIG. 2, when the door 200 is closed, the first end portion of the checker arm 40 at the vehicle body side may be positioned in a right end portion of the slit 15 (e.g., an end portion of the slit 15 which is farthest from the second bracket 20 or a first end portion of the slit 15). FIGS. 3, 4, and 5 illustrate top plan views of the door checker device with the door opened to the extent of about 30%, 50%, 70%, and 100%, respectively.

Referring to FIGS. 3 to 5, as the door 200 is opened, the second bracket 20 may be rotated based on the hinge shaft of the door 200, and the second end portion of the checker arm 40 at the door side may be rotated by the second hinge pin 32 based on the openings 25. Simultaneously, the first end portion of the checker arm 40 at the vehicle body side may be rotated by the first hinge pin 31, and may slide along the slit 15 toward a left end portion of the slit 15 (e.g., an end portion of the slit 15 which is closest to the second bracket 20 or a second end portion of the slit 15).

After the door 200 is fully opened, the first end portion of the checker arm 40 at the vehicle body side may be positioned in the left end portion of the slit 15 (e.g., the second end portion of the slit 15). As described above, the end portion of the checker arm 40 at the vehicle body side may slide along the slit 15 while the door 200 is opened and closed, and the door checker device 100 may implement a door checker function, using a sliding stroke of the end portion of the checker arm 40 at the vehicle body side.

The door checker device 100 described prevents interference by internal parts of the door 200 since it is positioned extraneous to the door 200. Accordingly, when designing the door 200 parts, difficulty in determining a layout of the door checker device 100 may be prevented, thereby increasing a degree of freedom in the design.

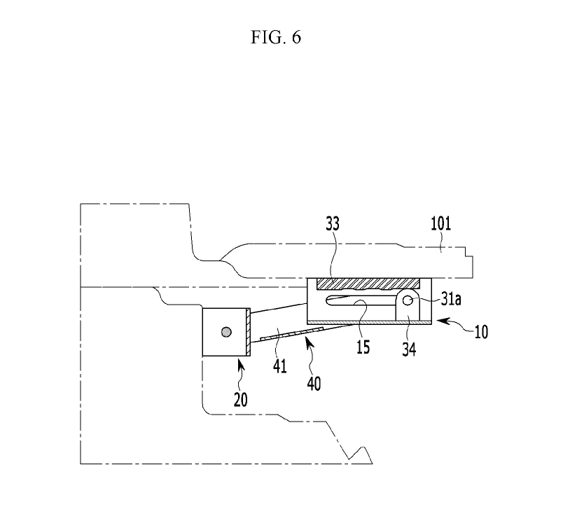

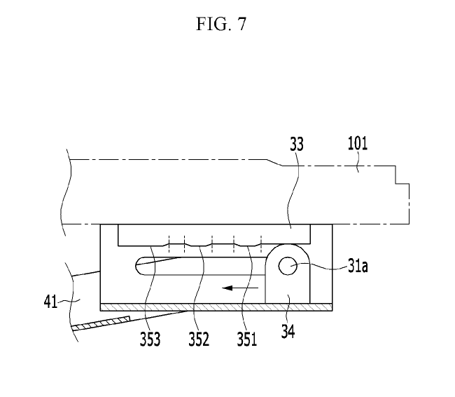

The door checker device 100 of the first exemplary embodiment may include a guide 33 and a slider 34 configured to generate a door holding force, when the door 200 is opened, to allow the door to maintain a stationary position where the door is held open. Referring to FIGS. 6 and 7, the guide 33 may be fixed, inside of the first bracket body 12, to the filler part 101 of the vehicle body, and may be positioned parallel to the slit 15. The slider 34 may be fixed to the shaft 31a of the first hinge pin 31, and one side of the slider 34 (e.g., a first side of the slider 34) may contact the guide 33. The first side of the slider 34 contacting the guide 33 may have a semicircular or arc shape. The guide 33 and the slider 34 may be manufactured by an injection molding using a synthetic resin. While the door 200 is opened or closed, the slider 34 may provide linear motion along the slit 15 along with the first hinge pin 31, and during the linear motion, the first side of the slider 34 contacts the guide 33 to cause friction therebetween. Since the door holding force may be generated by a frictional force between the guide 33 and the slider 34, the door 200 may maintain a stationary position when it is held open.

Furthermore, multi-layered detent protruding surfaces 351, 352, and 353 may be formed at one surface of the guide 33 (e.g., a first surface of the guide 33) that contacts the slider 34 to increase a frictional force with respect to the slider 34. The multi-layered detent protruding surfaces 351, 352, and 353 may include a plurality of protruding surfaces positioned along a moving direction of the slider 34 to be spaced apart from each other. For example, the multi-layered detent protruding surfaces 351, 352, and 353 may include, after the door 200 is closed, a first protruding surface 351 positioned to be closest to the slider 34, a second protruding surface 352 positioned to be spaced apart from the first protruding surface 351, and a third protruding surface 353 positioned to be spaced apart from the second protruding surface 352. The number of the protruding surfaces is not limited to the illustrated example.

As the door 200 is opened, the slider 34 may be configured to move and thus the contact position between the slider 34 and the guide 33 may change, and when one side of the slider 34 contacts the first protruding surface 351, the frictional force of the guide 33 and the slider 34 may increase to allow the door 200 to maintain the stationary state. When an amount of opening of the door 200 increases, one side of the slider 34 may pass between the first protruding surface 351 and the second protruding surface 352 to contact the second protruding surface 352 and the frictional force between the guide 33 and the slider 34 may increase to allow the door 200 to maintain the stationary state. When the amount of opening of the door 200 further increases, one side of the slider 34 may contact the third protruding surface 353 and the frictional force may increase to allow the door 200 to maintain the stationary state.

As described above, when the three detent protruding surfaces 351, 352, and 353 are formed in the guide 33, the door checker device 100 may provide three levels of detent senses (e.g., stationary sense), and the door 200 may be allowed to maintain the stationary state at particular specific amounts of opening (e.g., at varying opening degrees). After the door 200 is closed, the first protruding surface 351 may be spaced apart from the slider 34. Further, the third protruding surface 353 may extend to an edge of the guide 33, and may contact the slider 34 when the door 200 is fully opened. Accordingly, the door checker device 100 may be configured to reduce the frictional force when the closed door 200 begins to open, and may be configured to maintain the high frictional force when the opening of the door 200 exceeds a particular range, thereby allowing the door 200 to maintain the stationary state.

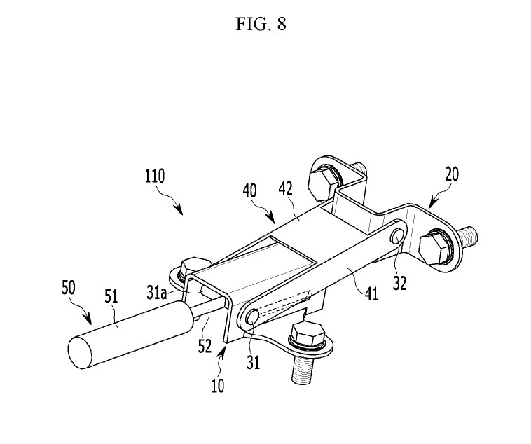

FIG. 8 is a perspective view of a door checker device according to a second exemplary embodiment of the present invention. Referring to FIG. 8, the door checker device 110 of the second exemplary embodiment may include a hydraulic pressure cylinder 50 configured to generate a door holding force. In other words, the door checker device 110 of the second exemplary embodiment may include the hydraulic pressure cylinder 50 instead of the guide 33 and the slider 34 of the first exemplary embodiment.

In particular, the hydraulic pressure cylinder 50 may include a cylinder 51 in which a fluid is accommodated and may be fixed to a filler part 101 of a vehicle body, and a piston rod 52 having a first end fixed to a shaft 31a of a first hinge pin 31 to provide linear motion together with the first hinge pin 31. When the door is opened, the first end portion of the piston rod 52 may be configured to provide linear motion along the slit 15, and the linear motion of the piston rod 52 may induce resistance of the fluid and thus generates a door holding force. The hydraulic pressure cylinder 50 may have various internal structures. For example, the hydraulic pressure cylinder 50 may have various functions such as changing a resistive force of the fluid according to an opening degree of the door, or adjusting an opening/closing speed of the door based on an opening degree of the door, etc.

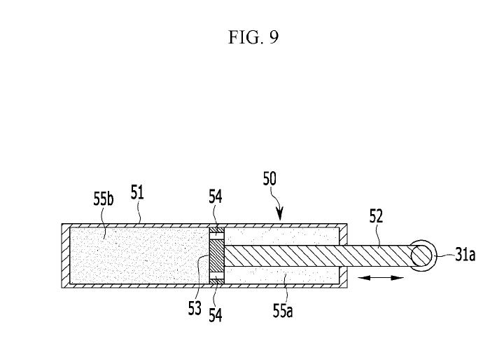

FIG. 9 is a cross-sectional view of one example of the hydraulic pressure cylinder 50. Referring to FIGS. 8 and 9, the fluid may be filled or accommodated in the cylinder 51 while being sealed therein, at least one orifice 54 for fluid movement may be formed in a piston 53 that contacts an inner wall of the cylinder 51. A first end of the piston rod 52 may be fixed to the shaft 31a of the first hinge pin 31, and a second end of the piston rod 52 may be fixed to the piston 53. The cylinder 51 may be divided into a first chamber 55a in which the piston rod 52 is positioned, and a second chamber 55b opposite the first chamber 55a.

When the door is opened, the fluid within the first chamber 55a may pass through the orifice 54 (e.g., aperture) and flow to the second chamber 55b. Further, when the door is closed, the fluid within the second chamber 55b may pass through the orifice 54 and flow to the first chamber 55a. During this process, a door holding force may be generated by the resistive force of the fluid, and the door may maintain the stationary state by the resistive force of the fluid after being opened. Since the door checker device 110 of the second exemplary embodiment has the same configuration as the above-described first exemplary embodiment, except for the hydraulic pressure cylinder 50, a duplicate description thereof will be omitted. In addition, in the second exemplary embodiment, the configuration of the hydraulic pressure cylinder 50 is not limited to the example illustrated in FIG. 9.

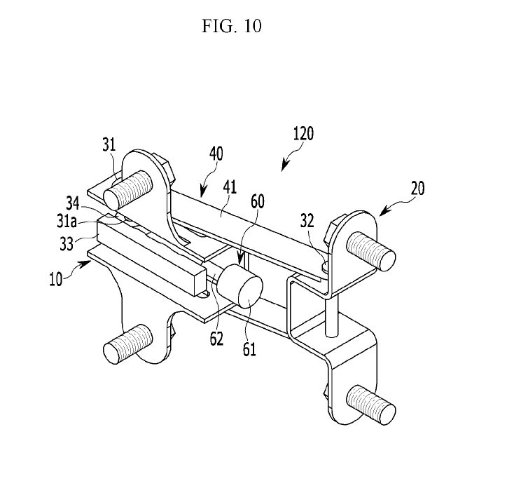

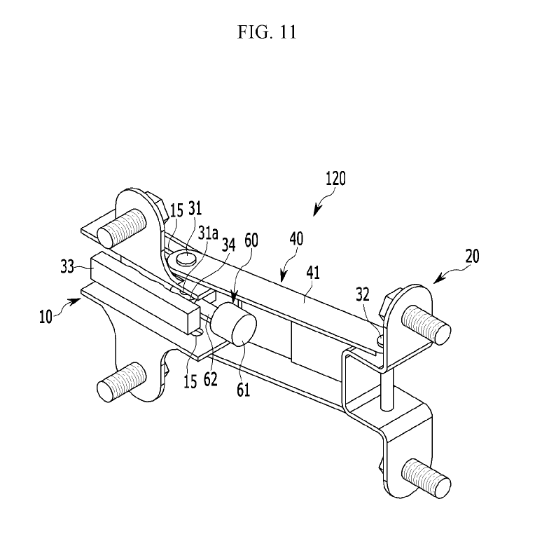

FIGS. 10 and 11 are perspective views of a door checker device of a third exemplary embodiment of the present invention, FIG. 10 illustrate when a door is closed, and FIG. 11 illustrates when the door is fully opened. Referring to FIGS. 10 and 11, the door checker device 120 of the third exemplary embodiment has the same configuration as the aforementioned first exemplary embodiment, except that a hydraulic damper 60 is further included. As in the first exemplary embodiment, like reference numerals designate like elements.

Particularly, a hydraulic damper 60 may be fixed to a filler part 101 of a vehicle body, and may contact the slider 34 to reduce a resistance force of a door when the door is fully opened. Specifically, the hydraulic damper 60 may have the same internal structure as the hydraulic pressure cylinder 50 illustrated in FIG. 9, but a piston rod 62 may not be fixed to other parts and may contact a slider 34 when the door is fully opened. After the door is closed, the piston rod 62 may be spaced apart from the slider 34. In FIGS. 10 and 11, the reference numeral 61 designates a cylinder.

When a user opens the door using a substantial amount of force, the door may be closed again due to a resistive force after being fully opened. While the door is being closed again, as a passenger enters the vehicle, the passenger may bump the door thus causing damage. This is called a resistive force of the door. When the door is fully open, the hydraulic damper 60 may be configured to reduce the resistive force of the door and the piston rod 62 contacting the slider 34 may slide toward the cylinder 61 to absorb an impact. Accordingly, even when the door is opened using a substantial amount of force, the hydraulic damper 60 may prevent the door from being closed again by reducing the resistive force of the door.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

### DESCRIPTION OF SYMBOLS

100, 110, 120: door checker device
101: filler part of vehicle body
102: hinge mounting part of door inner panel
200: door
10: first bracket
15: slit
20: second bracket
25: opening
31: first hinge pin
32: second hinge pin
33: guide
34: slider
351, 352, 353: detent protruding surface
40: checker arm
41: arm
42: connecting part
50: hydraulic pressure cylinder
60: hydraulic damper

What is claimed is:

1. A door checker device, comprising:
a first bracket fixed to a filler part of a side outer panel of a vehicle body side and formed with a slit parallel to a length direction of the vehicle body;
a second bracket fixed to a hinge mounting part of a door inner panel and formed with openings; and
a checker arm including a first end portion of the vehicle body rotatably and slidably combined with the first bracket and a second end portion of a door rotatably combined with the second bracket by a second hinge pin inserted into the openings.

2. The door checker device of claim 1, wherein the first bracket includes a pair of second horizontal portions disposed perpendicular to the filler part of the vehicle body and that vertically face each other, and the slit is formed in each of the pair of first horizontal portions.

3. The door checker device of claim 2, wherein the second bracket includes a pair of second horizontal portions disposed perpendicular to the hinge mounting part and that vertically face each other, and the openings are respectively formed in the pair of second horizontal portions.

4. The door checker device of claim 3, wherein the checker arm includes a pair of arms, the first hinge pin is inserted into a first end of the pair of arms and the pair of slits, and the second hinge pin is inserted into a second end of the pair of arms and the pair of openings.

5. The door checker device of claim 4, wherein a slider is fixed to a shaft of the first hinge pin, and a guide is fixed to an exterior of the filler part of the vehicle body that corresponds to a moving path of the slider to contact the slider.

6. The door checker device of claim 5, wherein an exterior surface of the guide that contacts the slider is formed with a plurality of detent protruding surfaces spaced apart from each other along a moving direction of the slider.

7. The door checker device of claim 6, wherein the plurality of detent protruding surfaces includes, after the door is closed, a first protruding surface spaced apart from the slider, at least one second protruding surface spaced apart from the first protruding surface, and a third protruding surface spaced apart from the second protruding surface to contact the slider, after the door is fully open.

8. The door checker device of claim 5, further comprising:
a hydraulic damper fixed to the filler part of the vehicle body and contacting the slider after the door is fully open to absorb an impact.

9. The door checker device of claim 1, further comprising:
a hydraulic pressure cylinder including a piston rod with a first end fixed to the first hinge pin for linear motion together with the first hinge pin.

10. The door checker device of claim 9, wherein the hydraulic pressure cylinder includes a cylinder body in which a fluid is accommodated in a sealed state, and a piston fixed to a second end of the piston rod inside the cylinder body and including at least one aperture.
